(19) United States
(12) Patent Application Publication
(10) Pub. No.: US 2011/0039753 A1
(43) Pub. Date: Feb. 17, 2011

(54) Fabric Care Emulsion

(76) Inventors: Severine Cauvin, Mons (BE); Christel Mariette Simon, Lobbes (BE); Andreas Stammer, Pont-A-Celles (BE); Stephane Ugazio, Soignies (BE)

Correspondence Address: DOW CORNING CORPORATION CO1232, 2200 W. SALZBURG ROAD, P.O. BOX 994, MIDLAND, MI, 48686-0994, US

(21) Appl. No.: 12/937,850

(22) PCT Filed: Apr. 9, 2009
(86) PCT No.: PCT/EP09/54286

§ 371 Date: Oct. 14, 2010

(30) Foreign Application Priority Data
Apr. 16, 2008 (GB) 0806900.7

(51) Int. Cl. C11D 3/60

(52) U.S. Cl. 510/327; 510/527

(57) ABSTRACT

The invention relates to oil-in-water emulsions, methods of making said emulsions and their uses in fabric care or hair care compositions. The fabric care composition comprises a silicone oil-in-water emulsion which emulsion is obtained by a. forming an oil phase by mixing at least one silicone compound with at least one silicone-free oil, b. optionally adding an emulsifier, c. adding water, d. forming an oil-in-water emulsion. A silicone oil, comprising a siloxane or polysiloxane compound, for example polydimethyl siloxane (polydimethyl silicone or PDMS), or a derivative thereof, e.g., amino and amido silicone, diluted with a silicone-free oil still can provide an emulsion providing high fabric care properties while decreasing the costs.

### TECHNICAL FIELD

This invention relates to oil-in-water emulsions, methods of making said emulsions and their uses in fabric care or hair care compositions.

### BACKGROUND AND PRIOR ART

Fabric softener compositions, especially those added in the rinse step of fabric washing cycle, are well known in the art.

Fabric softening compositions are classically composed of polyalkyl quaternary ammonium salts and more specifically of ester-linked quaternary ammonium fabric softening materials having one or more fully saturated alkyl chains.

It is also known to incorporate one or more additional materials such as silicones or polydiorganosiloxanes, to reduce wrinkling of the fabric during the rinsing and drying stages, to reduce the appearance of wrinkles or creases before ironing, to make ironing easier, to bring high fabric softening performances or to improve fabric re-wettability. Because of their structure and their low solubility, the fabric softening materials can have poor emulsification features. Thus, the addition of an oil, especially a silicone oil, to the fabric softener composition can be difficult due to coalescence of particles leading to product instability.

Silicone can be incorporated by various ways, including in situ emulsification of the silicone. Many prior art compositions describe the silicone incorporation in the form of a micro-emulsion, that is to say the silicone is present as liquid droplets having a droplet size less than the wavelength of visible light and so the emulsion is substantially transparent see for example WO92/01776. In a few cases, macro-emulsions are used (e.g. WO-A-97/31997). In these prior art compositions, the silicone is already emulsified before being added to the fabric softener formulation.

Even if the addition of pre-emulsified silicone to fabric softener formulations has been well-documented over the years, the use of such fabric care emulsion is limited due to their high cost per active weight. Besides silicone has a low biodegradable profile that could be a notable disadvantage certainly as environmental legislation continues to get tougher. In addition to these points when developing emulsion stabilized by solid particles (i.e. Pickering emulsions) viscosity can be a hurdle. Indeed as no surfactant is present in order to reduce the oil/water interfacial tension the formation of small oily droplets when using viscous oil can be difficult and requires a high level of mechanical energy in order to form small oily droplets see for instance WO2003055968.

Silicone containing compositions are also used in personal care applications like cosmetics and pharmaceutics applications. According to EPA 1306072, mixtures of silicone oils, such as dimethylpolysiloxanes and cyclomethicones, with organic oils have very good sensory and care properties, as a result of which they are highly suitable for use in cosmetic and pharmaceutical compositions. However the formulations require a compatibilizer in form of an organo modified silicone. WO 2007141565 describes amino-acid functional siloxanes used in personal care products like shampoo and skin creams, in water-in-oil or oil-in water silicone emulsions. Those formulations can contain a solvent, preferably in form of a short chain alcohol. US 2003/036490 describes oil in water emulsion for cosmetics, wherein a pre-homogenized oily phase made of low molecular weight siloxane compound with mineral oil is mixed with an aqueous phase containing an amphiphilic polymer. U.S. Pat. No. 6,465,402 describes siloxane elastomer emulsions which can contain additional fluids in the oil phase. WO2007/083256 and WO2005/105024 describe oil in water emulsion for personal care applications, wherein the oily phase contains a silicone compound.

EP A 0756864 and EP A 0850644 describe oily mixtures to be used in cosmetic applications such as lip stick or foundation to decrease transfer of the materials to clothes or other surfaces. KR20020057493 describes an oil-in-water type foundation containing a silicone-coated pigment.

WO 9909947 describes a rinse-off liquid personal cleansing composition comprising surfactant and water wherein the composition comprises a combination of 2 different surfactants in several ingredients which may comprise silicone oil and hydrocarbon oil.

In the field of laundry application, U.S. Pat. No. 7,335,630, U.S. Pat. No. 7,326,676 and US20050009720 describe an aqueous liquid laundry detergent for cleaning and imparting fabric care benefits i.e. a “2-in-1 liquid detergent”. The composition contains a detersive surfactant and droplets of silicone blend comprising a nitrogen-containing amino or ammonium functionalized polysiloxane and nitrogen-free non-functionalized polysiloxane.

There is still a need to develop silicone based emulsion technology that could provide fabric care benefits with cost in use effectiveness and improved environmental profile and which could be delivered from detergent formulation or fabric care composition.

There is a need to develop silicone based emulsion technology that could provide hair care benefits with cost in use effectiveness and improved environmental profile and which could be delivered from shampoo or conditioner.

### SUMMARY OF THE INVENTION

In one of its aspects, the invention provides a method of making a fabric care composition comprising a silicone oil-in-water emulsion which emulsion is obtained by
a. Forming an oil phase by mixing at least one silicone compound with at least one silicone-free oil,
b. Optionally adding an emulsifier or a solid particulate emulsifier,
c. adding water,
d. Forming an oil-in-water emulsion.

The invention also provides a fabric care composition comprising a silicone oil-in-water emulsion characterised in that the oil phase contains a silicone compound and silicone-free oil.

The invention further provides an oil-in-water emulsion wherein the oil phase contains a silicone compound and a silicone-free oil as well as the use of such oil-in-water emulsion in fabric care composition or in hair care composition like shampoo or conditioner

### DETAILED DESCRIPTION OF THE INVENTION

The present invention permits to provide fabric care silicone emulsions with improved cost-in use, environmental profile and ease of manufacturing of particle stabilized emulsions also known as Pickering emulsions.

We have found that a silicone oil, comprising a siloxane or polysiloxane compound, for example polydimethyl siloxane (polydimethyl silicone or PDMS), or a derivative thereof, e.g., amino and amido silicone, diluted with a silicone-free oil still can provide an emulsion providing high fabric care properties.

In the present description, a compound or mixture of compounds is named as an oil when it behaves as a fluid, for example it can be liquid, and it is not miscible with water.

Surprisingly, an emulsion comprising an oil phase wherein the silicone material is diluted with silicone-free oil permits to make fabric care composition with good softening performances, as observed by re-wettability and softening tests.

It was found that even if the diluent (diluting) oil does not have any fabric care benefits in itself, the fabric care benefits can be maintained while decreasing the costs. The invention permits to obtain fabric softeners showing high performances using cheaper ingredients than commercial fabric softeners including silicone.

An already polymerized silicone is preferably used, and is mixed with a silicone-free oil.

In some embodiments, the silicone compound (or a mixture of different silicone compounds) is used which has a low content of volatile siloxanes with a boiling point below 250° C. Preferably the silicone compound or the mixture of different silicone compounds contains less than 0.5% by weight of siloxanes of boiling point lower than 250° C. Preferably each siloxane of boiling point lower than 250° C. present in the silicone compound mixture forms less than 0.1% by weight of the silicone compounds.

This low volatility silicone compound or mixture can be prepared by evaporation or extracting the volatile species from the silicone or by using polymerization conditions that result in low volatility content. Such conditions can be, but are not limited to polymerization at low temperature, or use of catalysts that favour condensation reactions rather than equilibration.

Diluting the silicone compound or mixture can also decrease the oil phase viscosity hence facilitate the emulsification of the silicone material when processing.

The silicone free oil wherein the silicone compound is diluted can be compatible (miscible) with the silicone compound or not. When non compatible (not miscible) silicone-free oil is used, the silicone compound or mixture is not exactly diluted but dispersed in the non compatible oil. The mixing of the silicone compound with the oil needs to be made vigorously with appropriate shear to ensure fine dispersion of the silicone compound or mixture in the oil. This embodiment permits to use different oils than diluent, miscible oils, allowing different properties to be obtained. For example a silicone compound can be dispersed in sunflower oil providing interesting biodegradable properties to the product. This can be especially advantageous for fabric care products, where biodegradability might be an important characteristic.

Therefore, in a preferred embodiment, the invention extends to an oil-in-water emulsion wherein the oil phase contains a liquid-liquid dispersion of a silicone compound in a silicone-free oil which is not miscible with the silicone compound. Such emulsion can be advantageous for hair care or for fabric care compositions.

Mixing can be accomplished by any method known in the art to affect mixing of high viscosity materials. The mixing may occur either as a batch, semi-continuous, or continuous process. Mixing may occur, for example using, batch mixing equipments with medium/low shear include change—C an mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, Tex.). Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (N.J.); twin-screw counter-rotating extruders, two-stage extruders, twin-rotor continuous mixers, dynamic or static mixers or combinations of these equipments.

Emulsification can take place using various processing routes like phase inversion, thick phase process or by mechanical shear.

Preferably, the silicon-free oil has low viscosity, preferably comprised between 0.65 mPa.s at 25° C. and 10000 mPa.s at 25° C. More preferably, the viscosity is comprised between 2 and 1000 mPa s, most preferably 4 to 500 mPa s.

Preferably, the silicone-free oil is hydrocarbon oil. Preferably the silicone-free oil is of natural origin or derived from natural oil. Preferably, the oil is of mineral, vegetal or animal origin. Examples include linear or branched mono unsaturated hydrocarbons such as linear or branched alkenes or mixtures thereof containing at least 12, e.g. from 12 to 25 carbon atoms; and/or mineral oil fractions comprising linear (e.g. n-paraffinic) mineral oils, branched (iso-paraffinic) mineral oils, cyclic (referred in some prior art as naphthenic) mineral oils and mixtures thereof. Preferably the hydrocarbons utilised comprise at least 10, preferably at least 12 and most preferably greater than 15 carbon atoms per molecule.

Other preferred oil extenders include alkylcycloaliphatic compounds, low molecular weight polyisobutylenes, phosphate esters, alkybenzenes including polyalkylbenzenes which are unreactive with the polymer, esters of mono, di or poly carboxylic acids.

Any suitable mixture of oil fractions may be utilised as the diluent in the present invention but high molecular weight extenders (e.g. >220 gram/mole) are particularly preferred. Examples include:
alkylcyclohexanes (molecular weight >220 gram/mole); paraffinic hydrocarbons and mixtures thereof containing from 1 to 99%, preferably from 15 to 80% n-paraffinic and/or isoparaffinic hydrocarbons (linear branched paraffinic) and 1 to 99%, preferably 85 to 20% cyclic hydrocarbons (naphthenic) and a maximum of 3%, preferably a maximum of 1% aromatic carbon atoms. The cyclic paraffinic hydrocarbons (naphthenics) may contain cyclic and/or polycyclic hydrocarbons. Any suitable mixture of mineral oil fractions may be used, e.g. mixtures containing:
(i) 60 to 80% paraffinic and 20 to 40% naphthenic and a maximum of 1% aromatic carbon atoms;
(ii) 30-50%, preferably 35 to 45% naphthenic and 70 to 50% paraffinic and or isoparaffinic oils;
(iii) hydrocarbon fluids containing more than 60 wt. % naphthenics, at least 20 wt. % polycyclic naphthenics and an ASTM D-86 boiling point of greater than 235° C.;
(iv) hydrocarbon fluid having greater than 40 parts by weight naphthenic hydrocarbons and less than 60 parts by weight paraffinic and/or isoparaffinic hydrocarbons based on 100 parts by weight of hydrocarbons.

Preferably the oil based diluents or mixture thereof comprises at least one of the following parameters:
(i) a molecular weight of greater than 150, most preferably greater than 200;
(ii) an initial boiling point equal to or greater than 230° C. (according to ASTM D 86).
(iii) a viscosity density constant value of less than or equal to 0.9; (according to ASTM 2501)
(iv) an average of at least 12 carbon atoms per molecule, most preferably 12 to 30 carbon atoms per molecule;
(v) an aniline point equal to or greater than 70° C., most preferably the aniline point is from 80 to 110° C. (according to ASTM D 611);
(vi) a naphthenic content of from 20 to 70% by weight of the extender and a mineral oil based extender has a paraffinic content of from 30 to 80% by weight of the extender according to ASTM D 3238);
(vii) a pour point of from −50 to 60° C. (according to ASTM D 97);
(viii) a kinematic viscosity of from 1 to 20 cSt at 40° C. (according to ASTM D 445)
(ix) a specific gravity of from 0.7 to 1.1 (according to ASTM D1298) ;
(x) a refractive index of from 1.1 to 1.8 at 20° C. (according to ASTM D 1218)
(xi) a density at 15° C. of greater than 700 kg/m³ (according to ASTM D4052) and/or
(xii) a flash point of greater than 100° C., more preferably greater than 110° C. (according to ASTM D 93)
(xiii) a saybolt colour of at least +30 (according to ASTM D 156)
(xiv) a water content of less than or equal to 250 ppm
(xv) a Sulphur content of less than 2.5 ppm (according to ASTM D 4927)

The diluent may comprise a suitable non-mineral based natural oil or a mixture thereof, i.e. those derived from animals, seeds and nuts and not from mineral oils (i.e. not from petroleum or petroleum based oils) such as for example almond oil, avocado oil, beef tallow, borrage oil, butterfat, canola oil, cardanol, cashew nut oil, cashew nutshell liquid, castor oil, citrus seed oil, cocoa butter, coconut oil, cod liver oil, corn oil, cottonseed oil, cuphea oil, evening primrose oil, hemp oil, jojoba oil, lard, linseed oil, macadamia oil, menhaden oil, oat oil, olive oil, palm kernel oil, palm oil peanut oil, poppy seed oil, rapeseed oil, rice bran oil, safflower oil, safflower oil (high oleic), sesame oil, soybean oil, sunflower oil, sunflower oil (high oleic), tall oil, tea tree oil, turkey red oil, walnut oil perilla oil, dehydrated castor oils, apricot oil, pine nut oil, kukui nut oil, amazon nut oil almond oil, babasu oil, argan oil, black cumin oil, bearberry oil, calophyllum oil, camelina oil, carrot oil, carthamus oil, cucurbita oil, daisy oil, grape seed oil, foraha oil, jojoba oil, queensland oil, onoethera oil, ricinus oil, tamanu oil, tucuma oil, fish oils such as pilchard, sardine and herring oils. The diluent may alternatively comprise mixtures of the above and/or derivatives of one or more of the above.

A wide variety of natural oil derivates are available. These include transesterified natural vegetable oils, boiled natural oils such as boiled linseed oil, blown natural oils and stand natural oils. An example of a suitable transesterified natural vegetable oil is known as biodiesel oil, the transesterification product produced by reacting mechanically extracted natural vegetable oils from seeds, such as rape, with methanol in the presence of a sodium hydroxide or potassium hydroxide catalyst to produce a range of esters dependent on the feed utilised. Examples might include for example methyloleate

(CH₃(CH₂)₇CH═CH(CH₂)₇CO₂CH₃).

Stand natural oils which are also known as thermally polymerised or heat polymerised oils and are produced at elevated temperatures in the absence of air. The oil polymerises by cross-linking across the double bonds which are naturally present in the oil. The bonds are of the carbon-carbon type. Stand oils are pale coloured and low in acidity. They can be produced with a wider range of viscosities than blown oils and are more stable in viscosity. In general, stand oils are produced from linseed oil and soya bean oil but can also be manufactured based on other oils. Stand oils are widely used in the surface coatings industry.

Blown oils which are also known as oxidised, thickened and oxidatively polymerised oils and are produced at elevated temperatures by blowing air through the oil. Again the oil polymerises by cross-linking across the double bonds but in this case there are oxygen molecules incorporated into the cross-linking bond. Peroxide, hydroperoxide and hydroxyl groups are also present. Blown oils may be produced from a wider range of oils than stand oils. In general, blown oils are darker in colour and have a higher acidity when compared to stand oils. Because of the wide range of raw materials used, blown oils find uses in many diverse industries, for example blown linseed oils are used in the surface coatings industry and blown rapeseed oils are often used in lubricants.

The presence of silicone-free oil such as, for example, an oil of vegetal origin, can help to increase the biodegradability of the fabric composition, which is an advantage as environment concerns and legislation are becoming more and more important.

Preferably, the silicone compound comprises an amino or amido functionalised siloxane or polysiloxane compound.

The silicone oil can be any organopolysiloxane. Organopolysiloxanes are polymers containing siloxane units independently selected from (R₃SiO_{0.5}), (R₂SiO), (RSiO_{1.5}), or (SiO₂) siloxy units, where R may be any monovalent organic group. These siloxy units may be combined in various manners to form cyclic, linear, or branched structures. When R is a methyl group in the (R₃SiO_{0.5}), (R₂SiO), (RSiO_{1.5}), or (SiO₂) siloxy units of an organopolysiloxane, the siloxy units are commonly referred to as M, D, T, and Q units respectively. The chemical and physical properties of the resulting polymeric structures can vary. For example organopolysiloxanes can be volatile or low viscosity fluids, high viscosity fluids/gums, elastomers or rubbers, and resins depending on the number and arrangement of the siloxy units in the organopolysiloxane.

The organopolysiloxanes useful silicone oil in the present invention may contain any number or combination of (R₃SiO_{0.5}), (R₂SiO), (RSiO_{1.5}), or (SiO₂) siloxy units. The silicone oil may also be a mixture of two or more organopolysiloxanes. The organopolysiloxane may be selected, but limited to, those known in the art as silicone fluids, gums, elastomers or resins. The organopolysiloxane may also be selected, but limited to, those known in the art as “organofunctional” silicone fluids, gums, elastomers or resins.

In one embodiment of the present invention, the organopolysiloxane is a polydimethylsiloxane or a mixture of it. It can have a viscosity greater than 1000 mm²/s at 25° C., alternatively having a viscosity greater than 10,000 mm²/s at 25° C., alternatively having a viscosity greater than 100,000 mm²/s at 25° C. The “endblocking” group of the polydimethylsiloxane is not critical, and typically is either OH (i.e. SiOH terminated), alkoxy (RO), or trimethylsiloxy (Me₃SiO).

The organopolysiloxane may also be a mixture of various polydimethylsiloxanes of varying viscosities or molecular weights. Furthermore, the organopolysiloxane may also be a mixture of a high molecular weight organopolysiloxane, such as a gum, resin, or elastomer in a low molecular weight or volatile organopolysiloxane. The polydimethylsiloxane gums suitable for the present invention are essentially composed of dimethylsiloxane units with the other units being represented by monomethylsiloxane, trimethylsiloxane, methylvinylsiloxane, methylethylsiloxane, diethylsiloxane, methylphenylsiloxane, diphenylsiloxane, ethylphenylsiloxane, vinylethylsiloxane, phenylvinylsiloxane, 3,3,3-trifluoropropylmethylsiloxane, dimethylphenylsiloxane, methylphenylvinylsiloxane, dimethylethylsiloxane, 3,3,3-trifluoropropyldimethylsiloxane, mono-3,3,3-trifluoropropylsiloxane, aminoalkylsiloxane, monophenylsiloxane, monovinylsiloxane and the like.

The organopolysiloxane may be selected from any “organofunctional” silicone, known in the art for enhancing softening or feel of fabrics. For example, those organofunctional silicones known as amino, amido, epoxy, mercapto, polyether, functional, or modified, silicones may be used as silicone oil.

The organofunctional organopolysiloxanes may have at least one of the R groups in the formula RₙSiO_{(4-n)/2} being an organofunctional group. Representative non-limiting organofunctional groups include; amino, amido, epoxy, mercapto, polyether (polyoxyalkylene) groups, and any mixture thereof. The organofunctional group may be present on any siloxy unit having an R substituent, that is, they may be present on any (R₃SiO_{0.5}), (R₂SiO), or (RSiO_{1.5}) unit.

Amino-functional groups may be designated in the formulas herein as R^{N} and is illustrated by groups having the formula; —R¹NHR², —R¹NR₂², or —R¹NHR¹NHR², wherein each R¹ is independently a divalent hydrocarbon group having at least 2 carbon atoms, and R² is hydrogen or an alkyl group. Each R¹ is typically an alkylene group having from 2 to 20 carbon atoms. R¹ is illustrated by groups such as; —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. The alkyl groups R² are as illustrated above for R. When R² is an alkyl group, it is typically methyl.

Some examples of suitable amino-functional hydrocarbon groups are; —CH₂CH₂NH₂, —CH₂CH₂CH₂NH₂, —CH₂CHCH₃NH, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂(CH₃)CHCH₂NHCH₃, —CH₂CH₂CH₂CH₂NHCH₃, —CH₂CH₂NHCH₂CH₂NH₂, —CH₂CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

The emulsion preferably contains an emulsifier, whether in liquid, paste or solution form, also called surfactant, or an emulsifier which is in solid particulate form, i.e. Pickering emulsifier. The presence of an emulsifier helps to obtain an homogenous and/or stable oil phase.

When using a liquid emulsifier, any suitable surfactant or combination of surfactants may be utilised. The surfactant can in general be a non-ionic surfactant, a cationic surfactant, an anionic surfactant, or an amphoteric surfactant, although not all procedures for carrying out the process of the invention can be used with all surfactants. The amount of surfactant used will vary depending on the surfactant, but generally is up to about 30 wt. % based on the polydiorganosiloxane.

Examples of nonionic surfactants include condensates of ethylene oxide with long chain fatty alcohols or fatty acids such as a C₁₂₋₁₆ alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, fatty amine oxides, polyoxyalkylene alkyl ethers such as polyethylene glycol long chain (12-14C) alkyl ether, polyoxyalkylene sorbitan ethers, polyoxyalkylene alkoxylate esters, polyoxyalkylene alkylphenol ethers, ethylene glycol propylene glycol copolymers and alkylpolysaccharides, for example materials of the structure R²⁴—O—(R²⁵O)ₛ—(G)ₜ wherein R²⁴ represents a linear or branched alkyl group, a linear or branched alkenyl group or an alkylphenyl group, R²⁵ represent an alkylene group, G represents a reduced sugar, s denotes 0 or a positive integer and t represent a positive integer as described in U.S. Pat. No. 5,035,832. non ionic surfactants additionally include polymeric surfactants such as polyvinyl alcohol (PVA) and polyvinylmethylether.

Representative examples of suitable commercially available nonionic surfactants include polyoxyethylene fatty alcohols sold under the tradename BRIJ by Uniqema (ICI Surfactants), Wilmington, Del. Some examples are BRIJ 35 Liquid, an ethoxylated alcohol known as polyoxyethylene (23) lauryl ether, and BRIJ 30, another ethoxylated alcohol known as polyoxyethylene (4) lauryl ether. Some additional nonionic surfactants include ethoxylated alcohols sold under the trademark TERGITOL® by The Dow Chemical Company, Midland, Mich. Some example are TERGITOL® TMN-6, an ethoxylated alcohol known as ethoxylated trimethylnonanol; and various of the ethoxylated alcohols, i.e., C₁₂-C₁₄ secondary alcohol ethoxylates, sold under the trademarks TERGITOL® 15-S-5, TERGITOL® 15-S-12, TERGITOL® 15-S-15, and TERGITOL® 15-S-40. Surfactants containing silicon atoms can also be used.

Examples of suitable amphoteric surfactants include imidazoline compounds, alkylaminoacid salts, and betaines. Specific examples include cocamidopropyl betaine, cocamidopropyl hydroxysulfate, cocobetaine, sodium cocoamidoacetate, cocodimethyl betaine, N-coco-3-aminobutyric acid and imidazolinium carboxyl compounds.

Examples of cationic surfactants include quaternary ammonium hydroxides such as octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide and coco trimethyl ammonium hydroxide as well as corresponding salts of these materials, fatty amines and fatty acid amides and their derivatives, basic pyridinium compounds, quaternary ammonium bases of benzimidazolines and polypropanolpolyethanol amines. Other representative examples of suitable cationic surfactants include alkylamine salts, sulphonium salts, and phosphonium salts.

Examples of suitable anionic surfactants include alkyl sulphates such as lauryl sulphate, polymers such as acrylates/C₁₀₋₃₀ alkyl acrylate crosspolymer alkylbenzenesulfonic acids and salts such as hexylbenzenesulfonic acid, octylbenzenesulfonic acid, decylbenzenesulfonic acid, dodecylbenzenesulfonic acid, cetylbenzenesulfonic acid and myristylbenzenesulfonic acid; the sulphate esters of monoalkyl polyoxyethylene ethers; alkylnapthylsulfonic acid; alkali metal sulforecinates, sulfonated glyceryl esters of fatty acids such as sulfonated monoglycerides of coconut oil acids, salts of sulfonated monovalent alcohol esters, amides of amino sulfonic acids, sulfonated products of fatty acid nitriles, sulfonated aromatic hydrocarbons, condensation products of naphthalene sulfonic acids with formaldehyde, sodium octahydroanthracene sulfonate, alkali metal alkyl sulphates, ester sulphates, and alkarylsulfonates. Anionic surfactants include alkali metal soaps of higher fatty acids, alkylaryl sulphonates such as sodium dodecyl benzene sulphonate, long chain fatty alcohol sulphates, olefin sulphates and olefin sulphonates, sulphated monoglycerides, sulphated esters, sulphonated ethoxylated alcohols, sulphosuccinates, alkane sulphonates, phosphate esters, alkyl isethionates, alkyl taurates, and alkyl sarcosinates. One example of a preferred anionic surfactant is sold commercially under the name Bio-Soft N-300. It is a triethanolamine linear alkylate sulphonate composition marketed by the Stephan Company, Northfield, Ill.

The above surfactants may be used individually or in combination.

In other embodiments, the emulsion contains a solid particulate material acting as emulsifier.

The solid particulate material may be any solid particulate material compatible with fabric treatment compositions. For example, the solid particulate material may be selected from a clay, a zeolite, a silica and mixtures thereof. Preferably, the particulate material is a solid material comprising individual solid particles whose average (by number) size is in the range from 0.01 to 1000 microns. Preferably, the particle sizes are in general below 100 microns in diameter. More preferably, particles will have a particle size (i.e., a maximum dimension) within the range of from 0.01 to 50 microns.

The fabric conditioning composition preferably comprises a solid particulate material in an amount of from 0.01% to 50% by weight of the composition, more preferably from 0.1% to 20% by weight of the composition, e.g. from 1% to 10% by weight of the composition.

The solid particulate material may be a single solid particulate material or a mixture of different solid particulate materials.

It is particularly preferred that the solid particulate material is a clay as the clay may provide softening benefits in addition to perfume delivery to fabrics.

The clay typically comprises material classified as smectite-type. Suitable smectite-type clays are preferably impalpable, expandable, three-layer clays such as, for example, aluminosilicates and magnesium silicates having an action exchange capacity of at least 50 milliequivalents per 100 g of clay. The smectite-type clay preferably has a cationic exchange capacity of at least 75 milliequivalents per 100 g of clay, as determined by the well-known ammonium acetate method.

Smectite-type clays are well known in the art and are commercially available from a number of sources. In addition, suitable smectite-type clays may be synthesised by a pneumatolytic or hydrothermal process.

The smectite-type clay is preferably selected from the group consisting of: montmorillonite, bentonite, beidellite, hectorite, saponite, stevensite, and mixtures thereof. Where appropriate, the clays will have been subjected to the application of shear. The smectite-type clays may be sheared by processes well known to those in the art.

More preferably the smectite-type clay is selected from bentonite and hectorite or mixtures thereof.

An additional and/or alternative solid particulate material suitable for use in the composition is zeolite. Zeolites are typically aluminosilicates and synthetic zeolites are commercially available under the designations zeolite A, zeolite B, zeolite P, zeolite X, zeolite HS, zeolite MAP and mixtures thereof. Naturally occurring zeolites may also be used as the solid particulate material. In certain known detergent compositions, zeolites are included as detergent builders. Thus, zeolites are well known to those skilled in the art and need not be described in more detail herein.

Alternatively or additionally, the solid particulate material may be a silica compound.

The particulate emulsifier is preferably chosen from silica, tin oxide, titanium dioxide, magnesium silicate, for example talc, magnesium aluminium silicate and bentonite.

If the solid particulate material comprises more than one of the above-mentioned particulate material ingredients, then any combination of the ingredients may be present, in any of the amounts described above.

It is believed that the solid particulate material is effective in preventing coalescence of the composition because it coats the oil droplets. Such a composition may be known as a Pickering emulsion.

The silicone-containing emulsion can be a micro-emulsion or a macro-emulsion.

The amount of diluent which may be included in the composition will depend upon factors such as the purpose to which the composition is to be put, the molecular weight of the silicone-free oil(s) concerned etc. In general however, the higher the molecular weight of the oil(s), the less will be tolerated in the composition but such high molecular weight inert fluids have the added advantage of lower volatility. Typical oil emulsions compositions will contain up to 70%w/w silicone-free oil(s). More suitable polymer products comprise from 5-60%w/w of silicone-free oil(s). Preferably the silicone-free oil and the silicone compound are mixed in a weight ratio of 25:75 to 85:15. More preferably the silicone-free oil and the silicone compound are mixed in a weight ratio of 25:75 to 60:40

Compositions according to the invention can be part of a liquid detergent, forming a “2 in 1” detergent, or of a separate fabric softener usually added in the rinse cycle of washing.

Any conventional fabric softening agent may be used in the compositions of the present invention. The softening agents may be cationic, anionic or non-ionic.

Suitable cationic fabric softening agents are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions.

The fabric softening compounds are preferably compounds that provide excellent softening, and are characterised by a chain melting Lβ to Lα transition temperature greater than 25° C., preferably greater than 35° C., most preferably greater than 45° C.

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula:

R₅—N⁺(—R₅)[—(CH₂)ₚ-T-R₆]-R₇-T-R₆

wherein each R₅ group is independently selected from C₁₋₄ alkyl or hydroxyalkyl groups or C₂₋₄ alkenyl groups; each R₆ group is independently selected from C₈₋₂₈ alkyl or alkenyl groups; and wherein R₇ is a linear or branched alkylene group of 1 to 5 carbon atoms, T is

—C(═O)—O— or —O—C(═O)—

and p is 0 or is an integer from 1 to 5.

Di(tallowoxyloxyethyl) dimethyl ammonium chloride and/or its hardened tallow analogue is an especially preferred compound of this formula.

A second preferred type of quaternary ammonium material can be represented by the formula:

(R₅)₃N⁺—(CH₂)—CH(—OOCR₆)(—CH₂OCR₆)

wherein R₅, p and R₆ are as defined above.

A third preferred type of quaternary ammonium material are those derived from triethanolamine (hereinafter referred to as ‘TEA quats’) as described in for example U.S. Pat. No. 3,915,867 and represented by formula: (TOCH₂CH₂)₃N+(R₉) wherein T is H or (R₈—CO—) where R₈ group is independently selected from C₈₋₂₈ alkyl or alkenyl groups and R₉ is C₁₋₄ alkyl or hydroxyalkyl groups or C₂₋₄ alkenyl groups. For example N-methyl-N,N,N-triethanolamine ditallowester or di-hardened-tallowester quaternary ammonium chloride or methosulphate. Examples of commercially available TEA quats include Rewoquat WE18 and Rewoquat WE20, both partially unsaturated (ex. WITCO), Tetranyl AOT-1, fully saturated (ex. KAO) and Stepantex VP 85, fully saturated (ex. Stepan).

It is advantageous if the quaternary ammonium material is biologically biodegradable. Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride. Suitable cationic fabric softening materials are described in U.S. Pat. No. 7,026,277.

If desired, other materials can be added to either phase of the emulsions, for example perfumes, colorants, thickeners, preservatives, plasticisers or active ingredients such as pharmaceuticals. Additives typically used in silicone emulsion as: Preservatives, parfums, antifoams, freeze thaw stabilizer, inorganic salts to buffer pH, thickener. The fabric softening composition may further comprises at least one compound selected from the group consisting of liquid carriers; builders; suds suppressors; stabilizers; perfumes; chelating agents; colours; opacifiers; anti-oxidants; bactericides; neutralizing agents; buffering agents; phase regulants; dye-transfer inhibitors; hydrotropes; thickeners; perfumes; bleaches; bleach activators; bleach catalysts; optical brighteners; soil release actives; photoactivators; preservatives; biocides; fungicides; colour speckles; coloured beads; spheres or extrudates; sunscreens; fluorinated compounds; pearlescent agents; luminescent agents or chemi-luminescent agents; anti-corrosion and/or appliance protectant agents; alkalinity sources or other p11 adjusting agents; solubilising agents; processing aids; pigments; free radical scavengers; pH control agents; and mixtures thereof.

### Examples

### Fabrics Pre-Conditioning

This step was performed to remove silicone treatment made during manufacturing of fabrics and to be sure that loads were free of silicone before our specific treatment. Load was made with 5 new pillow cases and 4 little terry towels (30×50 cm)=1.0 kg This load was washed 4 times in the following conditions:
Prewash 1: Miele W934—long program—water hardness: 0° F.-20 g Dash powder—Temperature: 95° C.—Spin rate: 600 rpm
Blank 1: Miele W934—long program—water hardness: 0° F.—No detergent—Temperature: 95° C.—Spin rate: 600 rpm
Prewash 2: same conditions that in prewash 1
Blank 2: same conditions as blank 1

Complete cycle of pre-conditioning was always made in the same type of washing machine (W377, W934 or W715). In order to save some time, 3 loads could be pre-washed at the same time in the same washing machine. The total load is then 3.0 kg and the quantity of detergent powder was adjusted at 60 g.

### Fabric Treatment

Two or 3 treatments were made in parallel on 2 or 3 different washing machines at the same time. There was always one reference treatment and 1 or 2 treatments with product to be tested. All fabrics from different treatments were line-dried at the same time at room temperature (with a control of temperature and relative humidity for a set of comparison).

### Washing Conditions:

a. Miele W934
b. Load: 5 pillow cases and 4 little terry towels (30×50 cm)=1 kg
c. Water hardness: 0°fT
d. Temperature: 40° C.
e. Spin rate: 600 RPM
f. Detergent: DASH
g. Softener: prototype fabric softener

Washing machines were cleaned after treatment by performing a wash cycle at 95° C. without load. In case of treatment with softener, softener drawer was manually cleaned with water before cleaning wash cycle.

### Panel Test on Softness Benefit

This Test Was Performed To Determine The Softness Of Dry Fabrics (Towels In Particular) After Wash Cycle

Following questions were asked to 16 panellists. One terry towel is used for 4 panellists and after is replaced by another one.
a. “Which towel is the softer?”
b. “If the first fabric is the reference and quoted 5 on a scale of 1 to 10 how would you rate (the) other(s), considering 10 means very soft, smooth?”

### Sample Preparation

1. Emulsion of Different Fluids

Formulation of examples 1 to 3:
30 g fluid
1.75 g Volpo L4 (commercial emulsifier made of fatty alcohol ethoxylate)
1.25 g Volpo L23 (commercial emulsifier made of fatty alcohol ethoxylate)
30 g of water
Total=63 g→emulsion at 47.6% active
Process: Use of Dental mixer—mix for 20 seconds after each step
   Blend of fluids+Volpo L4+molten Volpo L23
   5*2 g of water—mix after each addition)
   Remaining water

Silicone 1 is an aminofunctional polysiloxane used in textile softeners. G250 is a mineral oil available from Total Petrochemicals as Hydroseal G250H. It is an organic extender based on hydrocarbons derived from petroleum distillates. It has a cinematic viscosity of 3.3 to 3.7 cSt at 40 C with a density of 0.81.
2. Fabric Softener at 5% Quat:

Formulation:
55.6 g Tetranyl L1/90 standard (fabric softener sold by KAO, based on hydrogenated Tallow ester quat)
8 g MgCl₂.6H₂O solution @ 20%
936.4 g of water
Total=1000 g→5% active Quat
Process: Classical KAO Process
   Add molten Quat in hot water at 55° C. and mix for 15 minutes at 150 rpm—55° C.).
   Mix through Ultraturrax for 15 seconds at 8000 rpm)
   Cool down under mixing at 150 rpm to ˜30° C.).
   Add salt solution and mix for 15 minutes at 150 rpm
3. Fabric Softener at 5% Quat+1% Silicone 1

Formulation:
11.1 g Tetranyl L1/90 standard
2 g Silicone 1 fluid
2 g Tween® 20 (commercial polysorbate surfactant)
1.6 g MgCl₂.6H₂O solution @ 20%
183.3 g water
Total: 200 g→5% active Quat+1% active Silicone 1
Process: Polymer in Quat Process
   Quat+Silicone 1+Tween® 20—heat to 55° C.—150 rpm
   Add cold water in equal quantity of Quat+fluid+Ni surfactant—mix for 5 minutes at 150 rpm—55° C.).
   Add remaining cold water in 2 steps and mix for 5 minutes at 150 rpm—55° C. after each addition
   Mix through Ultraturrax for 10 seconds at 8000 rpm
   Cool down under mixing at 150 rpm to ˜30° C.).
   Add salt solution and mix for 15 minutes at 150 rpm
      Evaluation with 1% Active Matter.

Percentage active matter means the percentage of silicone emulsion or of silicone/oil emulsion.
1. Comparison Quat Alone/Quat+Silicone 1/Quat+Blend 50/50 Silicone 1/G250 Oil

TABLE 1a

| | Average | Nb of Panellists | |
|---|---|---|---|
| Quat + Silicone 1 | 6.1 | 13 | Comparative 1 |
| Quat + blend 50/50 | 6.2 | 14 | Example la |
| Silicone 1/G250 oil | | | |
| Quat alone | 5 | | Reference |

Both Quat boosted with pure Silicone 1 amino fluid and with blend 50/50 Silicone 1/G250 oil were significantly better than the Quat alone.

Example 1 was repeated and compared to Quat alone and to an emulsion of pure mineral oil. The percentage active was still 1%.

TABLE 1b

| | Average | Nb of Panellists | |
|---|---|---|---|
| Quat + blend 50/50 | 5.8 | 12 | Example 1b |
| Silicone 1/G250 oil | | | |
| G250 mineral oil alone | 4.7 | 6 | Comparative |
| Quat alone | 5 | | Reference |

Thus an emulsion formed from oil alone does not bring any benefit for softness it is even slightly detrimental to the softness properties
2. Quat Alone/Quat+Silicone 1/Quat+Blend 20/80 Silicone 1/G250 Oil

TABLE 2

| | Average | Nb of Panellists | |
|---|---|---|---|
| Quat + pure Silicone 1 | 5.1 | 10 | Comp. 2 |
| Quat + blend 20/80 Silicone 1/oil | 4.9 | 7 | Example 2 |
| Quat alone | 5 | | Reference |

The blend 20/80 Silicone 1/oil was prepared from 6 g Synperonic 13/9 (commercial surfactant based on isodecyl alcohol ethoxylate) instead of the Volpo surfactants, with 55 g blend fluid and 39 g water.

Process: (Using Magnetic Stirrer):
mix Synperonic with 12% of water
Add slowly blend under mixing
Add remaining water

The blend with highly diluted silicone did not give softness benefit compared to fabric softener quat alone.
3. Quat Alone/Quat+Blend 50/50 60, Silicone 2/G250 Oil

Silicone 2 is a polydimethoylsiloxane fluid of 60,000 cSt. It is emulsified in presence of silicone-free oil or in absence of silicone-free oil for comparative examples.

TABLE 3

| | Average | Nb of Panellists | |
|---|---|---|---|
| Quat + Silicone 2 | 6.1 | 14 | Comp. 3 |
| Quat + blend 50/50 Silicone 2/oil | 5.3 | 10 | Example 3 |
| Quat alone | 5 | | Ref. |

Quat containing Silicone 2 emulsion was much better than the quat alone while Quat+blend 50/50 Silicone 2/G250 oil was slightly better than Quat alone.
4. Quat Alone/Quat+Silicone 3/Quat+Blend 50/50 Silicone 3/G250 Oil

Silicone 3 is an amidomethypropyl siloxane emulsified in presence of G250. When Silicone 3 is used without G250, it is incorporated in the form of an oil-in-water micro-emulsion.

TABLE 4

| | Average | Nb of Panellists | |
|---|---|---|---|
| Quat + Silicone 3 | 5.3 | 10 | Comp. 3 |
| Quat + blend 50/50 Silicone 3/oil | 5.3 | 9 | Example 3 |
| Quat alone | 5 | | Reference |

Surprisingly, the blend 50/50 Silicone 3/G250 oil gives the same softness benefit as the Silicone emulsion while the amount of amidosilicone is decreased.

Evaluation with 3% active matter
5. Quat Alone/Quat+Silicone 3/Quat+Blend 50/50 Silicone 3/Oil

TABLE 5

| 3% active | Average | Nb of Panellists | |
|---|---|---|---|
| Quat + Silicone 3 | 5.8 | 13 | Comp. 4 |
| Quat + blend 50/50 | 5.3 | 10 | Example 4 |
| Silicone 3/G250 oil | | | |
| Quat alone | 5 | | Reference |

In this case, Silicone 3 emulsion improved the performance with a significant number of panellists preferring this formulation to the Quat alone. The blend of Silicone 3 and mineral oil slightly improved softening benefit compared to fabric softener alone.

### Water Absorbency Benefit

Besides softness, water absorbency properties are an important criteria for fabric softeners.

Towels (coming from treatment at 1% active) were used to test water absorbency benefit.

Ten pieces of 2*2 cm are cut near the border of the towel.

A cleaned 250 ml beaker was filled with soft water. A test specimen was dropped from approximately 10 mm above the water surface and the time the fabric piece took to sink below the surface of the water was measured using a stopwatch.

If the piece does not sink within 10 minutes, it is reported as “Floated”. The average time for the pieces to sink was recorded.

Results were captured in an Excel spreadsheet that calculated the average results and translate technical results for the silicone treatment into the following “easy-to-understand” quotation for the selection guide using the following rule:
Time below 10 S→“++”
Time between 10-60 S→“+”
Time between 60-300 S→“=”
Time superior to 300 S→“−”

TABLE 6

| Product | Water absorbency | Rating |
|---|---|---|
| Quat alone | 128.4 | = |
| Quat + Silicone 1 | 46 | + |
| Quat + blend 50/50 Silicone 1/G250 | 23 | + |
| Quat + blend 20/80 Silicone 2/G250 | 32 | + |
| Quat + Silicone 2 emulsion | 6 | ++ |
| Quat + blend 50/50 Silicone 2/G250 | 7 | ++ |
| Quat + Silicone 3 emulsion | 9 | ++ |
| Quat + blend 50/50 Silicone 3/G250 | 31 | + |

Use of blend of Silicone/mineral oil gave a significant improvement of the water absorbency benefit compared to a formulation with Quat alone. Depending on the silicone used, results obtained were almost as good as the ones obtained with usual silicone emulsions containing silicone not diluted in mineral oil for some silicones, equivalent or even better than undiluted silicone emulsions.

### Examples 5 and 6

### Silicone/Sunflower Oil

Emulsion Preparation

80p of Silicone 4 (hydroxyl terminated polydimethylsiloxane having a number average molecular weight of 94500 g/mol and a polydispersity index of 2.05) were mixed in an IKA mixer with 20p of sunflower oil at 70° C. to obtain a milky dispersion. Mixing was stopped and 1 g Volpo® L4, 1.6 g and Volpo® L23 was added to 50 g of the warm polymer/sunflower oil blend described above and mixed for 20 s at 3000 rpm in a Hausschild dental mixer. An additional 1.0 g of water was added and mixing repeated under the same conditions. Further additions of water and mixings were carried until 47.4 g water had been added in total, yielding an emulsion with 50% active. The resulting emulsion had a particle size of D(v, 0.1) μm=0.29, D(v, 0.5) μm=0.97 and D(v, 0.9) μm=1.94. It is a non homogenous although stable macro-emulsion used in Example 5.

70p of a Silicone 5 (hydroxyl terminated polydimethylsiloxane having a number average molecular weight of 65500 g/mol and a polydispersity index of 2.29) were mixed in an IKA mixer with 30p of sunflower oil at 90° C. to obtain a milky dispersion. Mixing was stopped and 1.1 g Volpo® L4, 1.8 g and Volpo® L23 was added to 50.2 g of hot the polymer/sunflower oil blend described above and mixed for 20 s at 3000 rpm in a Hausschild dental mixer. An additional 1.0 g of water was added and mixing repeated under the same conditions. Further additions of water and subsequentially mixing were carried until 46.9 g water had been added in total, yielding an emulsion with 50% active. The resulting emulsion used in Example 6 had a particle size of D(v, 0.1) μm=0.19, D(v, 0.5) μm=0.53 and D(v, 0.9) μm=2.09.

Comparative: same procedure but with 100 parts commercial silicone emulsion sold for textile treatment, based on hydroxyl-terminated dimethylsiloxane.

TABLE 7

| | Time | | |
|---|---|---|---|
| | (seconds) | Rating | |
| Softener + 1% commercial emulsion | 71.5 | = | Comparative |
| Softener + 1% blend 80/20 Silicone | 17.40 | + | Example 5 |
| 4/Sunflower oil | | | |
| Softener + 1% blend 70/30 Silicone | 3.2 | ++ | Example 6 |
| 5/Sunflower oil | | | |

Surprisingly, the emulsions with silicone diluted in Sunflower oil gave better water absorbency than the commercial emulsion. The result was even better for Silicone 5 with higher dilution.

Preparation of Pickering Emulsions
1. Preparation of Talc Dispersion (Solution A)
   30.0 g of Talc HTP Ultra 5 (IMI FABI) and 400 g of deionised water are placed and mixed in a 500 ml glass bottle (150 rpm with a 4-blades metal stirrer on an IKA rotor). After five minutes of stirring, 3.2 g of an alkoxysilane containing trimethoxysilyl propyl ethylene diamine is dropped in the dispersion of talc. After two hours of stirring, the dispersion is ready to be used.
2. Preparation of Laponite Dispersion (Solution B)
   12.04 g of Laponite XLG (Rockwood), 403 g of deionised water and 0.18 g of same silane are added one after the other in a 500 ml glass bottle and mixed under high shear during 4 hours (800 rpm with a 4-blades metal stirrer on an IKA rotor). After the stirring, the mixture is ready to be used.
3. Emulsification

Emulsion c1
19.5 g of solution A is poured into a 250 ml high beaker. 30.3 g of deionised water and 25.5 g of solution B are then added to the solution A. This dispersion is mixed 10 seconds at high shear (21500, Ultra-Turrax IKA). 20.2 g of Silicone 2 is poured in the beaker on top of the dispersion. The solution is placed under high shear for two minutes (6500 rpm, Ultra-Turrax IKA).
No emulsion could be formed and a two phases system was observed composed of the water phase at the bottom and the oil phase on top. The latter phase seems to contain the majority of the talc particles as it appears whitish.

Emulsion c2
19.6 g of solution A is poured into a 250 ml high beaker. 30.4 g of deionised water and 25.9 g of solution B are then added to the solution A. This dispersion is mixed 10 seconds at high shear (16400, Ultra-Turrax IKA). 20.9 g of a mixture of Silicone 2 and G250 (50:50 wt %) is poured in the beaker on top of the dispersion. The solution is placed under high shear for two minutes (5400 rpm, Ultra-Turrax IKA). A creamy and white emulsion can be formed.

1. A method of making a fabric care composition comprising a silicone oil-in-water emulsion which emulsion is obtained by
a) forming an oil phase by mixing at least one silicone compound with at least one silicone-free oil,
b) optionally adding an emulsifier,
c) adding water,
d) forming an oil-in-water emulsion.

2. The method in accordance with claim 1 characterised in that the silicone-free oil is hydrocarbon oil or natural oil, which is vegetal, animal or mineral.

3. The method according to claim 1 characterised in that the silicone-free oil and the silicone compound are mixed in a weight ratio of 25:75 to 85:15.

4. The method according to claim 1, characterised in that the silicone compound contains less than 0.5% by weight of siloxanes of boiling point lower than 250° C.

5. A fabric care composition comprising a silicone oil-in-water emulsion characterised in that the oil phase contains a silicone compound and silicone-free oil.

6. The fabric care composition according to claim 5 characterised in that the composition has improved water absorbency compared to a silicone oil-in water emulsion not containing the silicone-free oil.

7. The fabric care composition according to claim 5, characterised in that the silicone compound is an amino or amido functionalised siloxane or polysiloxane compound.

8. The fabric care composition according to claim 5, characterised in that the composition contains an emulsifier.

9. The fabric care composition according to claim 5, characterised in that the oil phase contains a particulate emulsifier chosen from silica, tin oxide, titanium dioxide, magnesium silicate, magnesium aluminium silicate and bentonite.

10. The fabric care composition according to claim 5, characterised in that the composition contains a fabric softener.

11. Oil-in-water emulsion wherein the oil phase contains a liquid-liquid dispersion of a silicone compound in a silicone-free oil which is not miscible with the silicone compound.

12. Oil-in-water emulsion according to claim 11, wherein the silicone-free oil is a natural oil not miscible with the silicone.

13. Oil in water emulsion according to claim 11 where the silicone compound is a polydimethylsiloxane or a mixture of polydimethylsiloxanes with a viscosity greater than 10000 mm²/s at 25° C.

14. A fabric care composition comprising an oil-in-water emulsion comprising an oil phase containing a silicone compound and a silicone-free oil.

15. A liquid detergent composition comprising a detergent compound, a fabric softener and an oil-in-water emulsion comprising an oil phase containing a silicone compound and a silicone-free oil.
